(19) United States
(12) Patent Application Publication
(10) Pub. No.: US 2010/0121881 A1
(43) Pub. Date: May 13, 2010

(54) Mobile Device Image Logging

(75) Inventor: William O'Hern, Spring Lake, NJ (US)

Correspondence Address: AT & T Legal Department - WS;Attn: Patent Docketing, Room 2A-207, One AT & T Way, Bedminster, NJ, 07921, US

(73) Assignee: AT&T INTELLECTUAL PROPERTY I, L.P., Reno, NV (US)

(21) Appl. No.: 12/268,572

(22) Filed: Nov. 11, 2008

(51) Int. Cl. G06F 17/30; H04M 3/42; G06F 7/00

(52) U.S. Cl. 707/783; 455/414.1; 707/E17.031

(57) ABSTRACT

Images transferred and received via a mobile device are logged. At a network node, images transferred to or from the mobile device are received and then stored on a network data storage device. Access to the images on the network data storage device is provided only to an authorized user. The images may be saved within a sliding time window. An authorized user may restrict future communication between the mobile device and another mobile device which received or sent an image.

The present invention relates generally to electronic device monitoring, and more particularly to a method of logging images transferred to and from an electronic device.

### BACKGROUND OF THE INVENTION

Cellular phones, personal digital assistants and, in some cases, even standalone digital cameras and other mobile devices are often equipped with the ability to transfer images and video from one device to another. Due to the proliferation of mobile devices with photo and video capability, sometimes combined with internet access, it has become increasingly difficult to control what content is accessed by a user of such a device. It is difficult, for example, for a parent to know what his/her child is viewing, or for a manager to know what his/her employees are viewing on company-owned devices.

Many schools have decided to ban such devices outright because inappropriate content cannot be controlled. However, such devices may be very useful when a parent needs to contact a child, or the child is an emergency situation. In other situations, it may even be desired for a child (or employee) to have the ability to send and receive images. Images of family, friends, or a place that the user of a mobile device is trying to find may be enjoyable or provide helpful information. Sometimes, a picture is simply more helpful than words

Thus, there is a need to provide some control over images on a mobile device. The extremes of the prior art, namely, allowing unfettered usage of imaging features of mobile devices or not allowing such usage at all, are often unacceptable.

### BRIEF SUMMARY OF THE INVENTION

Embodiments of the present invention comprise a method and device for logging images transferred and received via a mobile device. A network node receives images transferred to or from a mobile device. The node stores the received images on a network data storage device, and provides access to the images only to an authorized user. The stored images may be reduced quality or original versions of the received images. The storing may comprise saving images received at the network node within a sliding time window, such as saving only images which have been received within the last 30 minutes, 24 hours, or 1 week.

In one embodiment, a restriction command may be received from the authorized user in order to restrict communication between the mobile device and another mobile device based on the restriction command. In another embodiment, the restriction command may identify a stored image, and the mobile device that transferred the identified image may be restricted. Alternatively, the restriction command may identify a stored image and the mobile device that received the identified image may be restricted.

The authorized user may be a mobile telephone plan subscriber, and the mobile device may be a mobile telephone within the mobile telephone plan.

### BRIEF DESCRIPTION OF THE DRAWINGS

FIG. 1 shows a high level illustration of the prior art methods and devices of transferring images between mobile devices;

FIG. 2 shows a high level illustration of methods and devices of the embodiments of the present invention;

FIG. 3 shows a high level illustration of a device in accordance with an embodiment of the present invention;

FIG. 4 shows a flow chart of a method of storing images for an authorized user in embodiments of the present invention; and

FIG. 5 shows a flow chart of a method of restricting communication between a mobile device and another mobile device in an embodiment of the invention.

### DETAILED DESCRIPTION

Embodiments of the present invention comprise a method and device for logging images transferred and received via a mobile device, such as a cellular phone, personal digital assistant, laptop, and the like. At a network node, images transferred to or from a mobile device are received and then stored on a network data storage device. Access to the images on the network data storage device is provided only to an authorized user. The stored images may be reduced quality or original versions of the received images. The images may be saved within a sliding window, such as a quantity window, i.e., the last 5, 10, 20, or 100 images which have been received, or a time window, such as the past 30 minutes, 24 hours, or 1 week. Based on the stored images, the authorized user (which may be a single user or group of users falling within a class having access to the images stored on the network data storage device) may restrict future communication between the mobile device and another mobile device which received or sent the images.

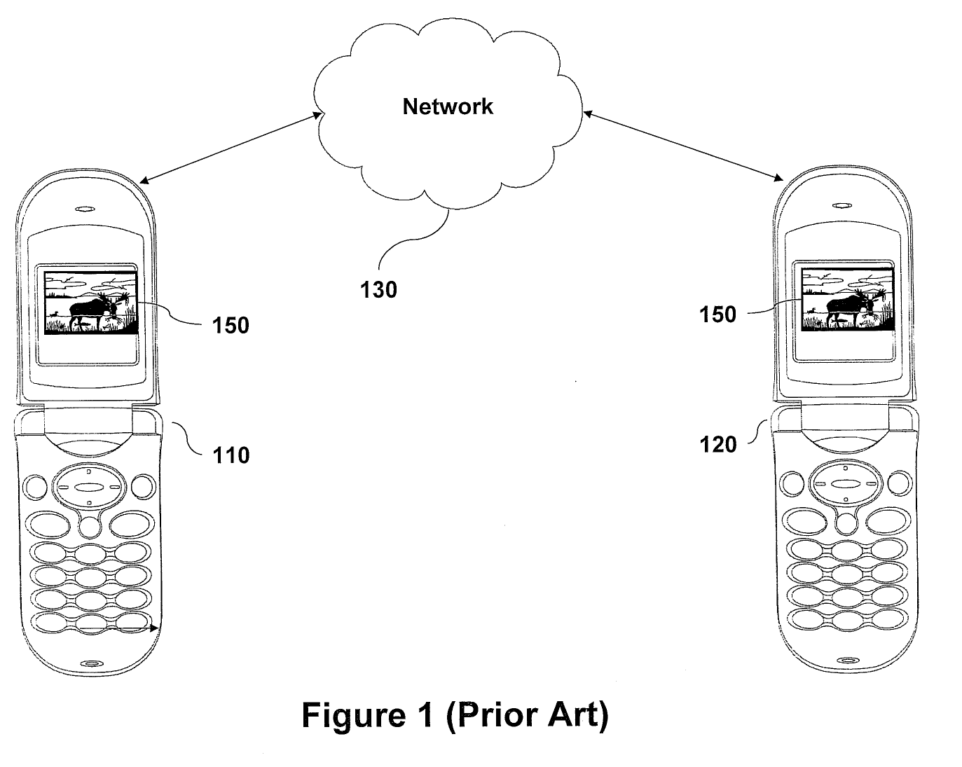

FIG. 1 shows a high level illustration of the prior art methods and devices of transferring images between mobile devices. Mobile device 110 displays an image 150 to be sent to another mobile device. When a user of the mobile device 110 desires to send this image to mobile device 120, it may be sent over the wireless network 130 to mobile device 120. Mobile device 120 may then display the image 150. It should be understood that transferring the images via a wireless network 130 is one of many ways in which an image may be transferred between mobile devices. The wireless network may be a cellular network, a packet switched network (e.g. the internet) or a short range wireless system such as infrared or Bluetooth, or a direct link via a cable between the devices, and the like. Any combination of such networks is also contemplated and within the scope of the invention.

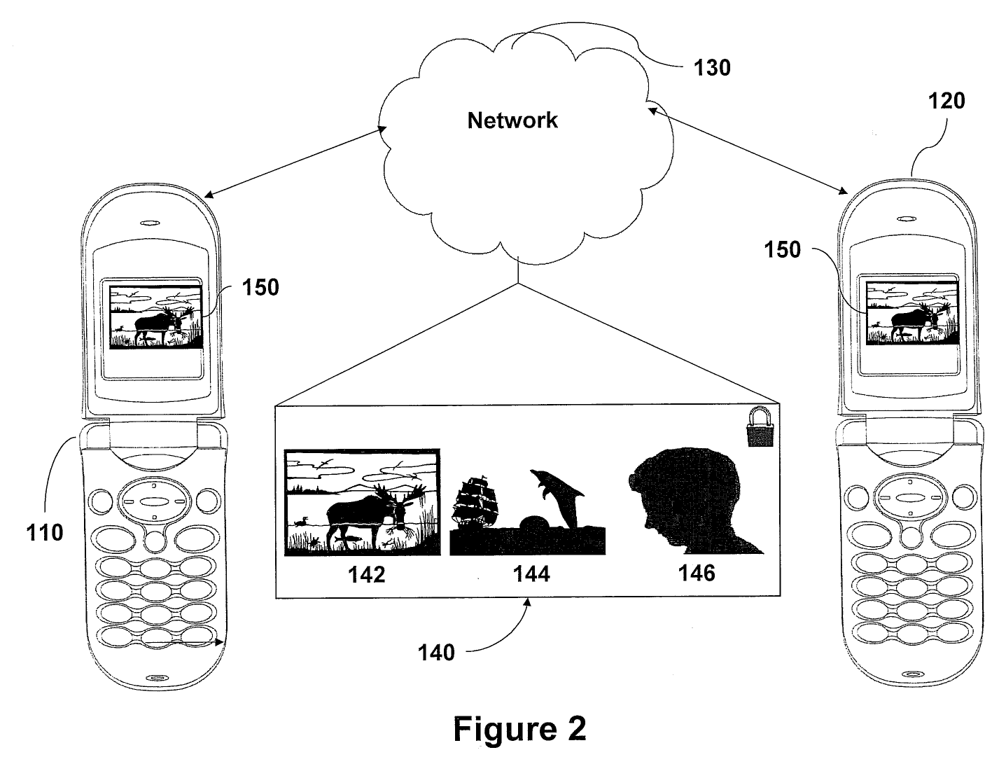

FIG. 2 shows a high level illustration of methods and devices of embodiments of the present invention. The mobile devices 110 and 120 may, at times, exchange an image 150 to and from each other via a wireless or other network 130, or other means of communication as described with reference to FIG. 1 or known in the art; but, additionally, the images, such as image 142, image 144, and image 146, may be stored on a network data storage device. The stored images 142, 144, 146 may be original versions of the images transferred between the mobile devices 110 and 120 or may be reduced quality versions, such as thumbnails and/or reduced resolution, a reduced color palette, or higher compression. The network storage device 140 may store various versions of an image, such as image 142, which is recognizable as part or all of the original image, such as image 150, by an average observer of such images. The original version of image 150 may be stored as an image 142 in the network storage device.

In embodiments of the invention, one of the mobile devices, such as mobile device 110, is logged. By logging the device, all images transferred to the device or sent from the device are farther sent to the network storage device 140. These images are provided to an authorized user, such as an owner of a phone plan associated with the mobile device or a parent or employer of a user of the mobile device 110. The log of mobile device 110 may include only those images which are sent or received by mobile device 110. While any mobile device may be logged, for purposes of this disclosure, mobile device 110 will be used as an example of a logged mobile device.

Access to images stored on the network storage device 140 is secured and provided only to an authorized user, such as an owner of a phone service plan. A mobile device, such as mobile device 110, may be within a mobile telephone plan, and the authorized user may be a mobile telephone plan subscriber. The term “authorized user,” again, may refer to a single individual or any individual within a group of people who have legitimate access to the secure images on the network storage device. In embodiments of the invention, the mobile device 110 may be a device associated with day-to-day usage by a person other than a person who pays for a network service plan for the device. A user of such a mobile device 110 may be excluded from being an authorized user.

The images (or versions thereof) are received at a network node for placement into the network storage device 140. The images may be sent to the network storage device 140 by any one of the devices used during transmission of the images. For example, a cellular provider may route a copy or version of the image 150 to the network storage device during transmission through the wireless network.

Referring again to FIG. 2, the images, such as images 142, 144, and 146 stored in the network storage device 140, may be the most recently transferred images received and sent by a mobile device, such as mobile device 110, and, by way of example, may be a rolling log. The most recent pictures may be saved in the network storage device and displayed in order of receipt or reverse order of receipt. The images may also comprise, or be sent with, meta data indicating such features as a time stamp or information about the sending or receiving party, including phone number (Caller ID, ANI, DID, RDNIS, forwarding number, or the like), IP address, or other identifying information.

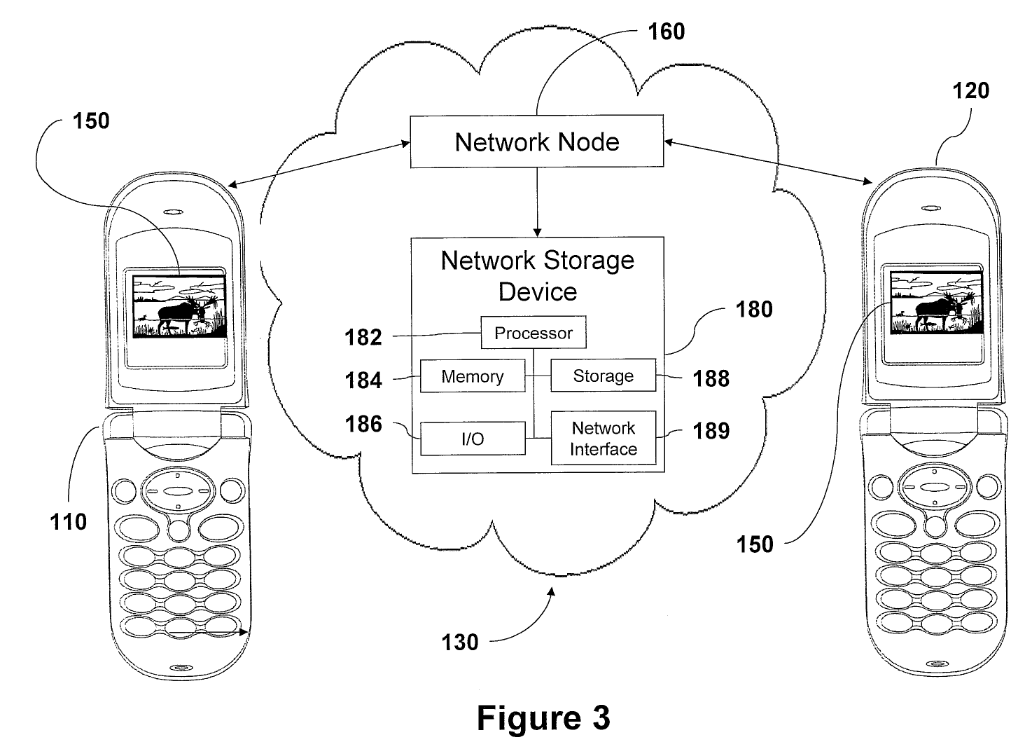

FIG. 3 shows a high level illustration of a device in accordance with an embodiment of the present invention. An image or a plurality of images transferred from or to a mobile device, such as mobile device 110, is received at a network node 160 which is situated somewhere within the network 130 (described above). The network node 160 may be a router, switch, or computing device as is known in the art of data network connections. The network node 160 may be responsible for forwarding data to or from either of the mobile devices 110 or 120. From the network node 160, a version, or original, of an image or images is sent to the network storage device 180 (which may be the network storage device 140 described in FIG. 2). The network storage device 180 comprises, a storage unit 188 (e.g. magnetic media, solid state media, or optical media) capable of storing images. In the embodiment shown in FIG. 3, the network storage device 180 is a separate network element. In alternative embodiments, the network storage device may be part of the network node 160 itself.

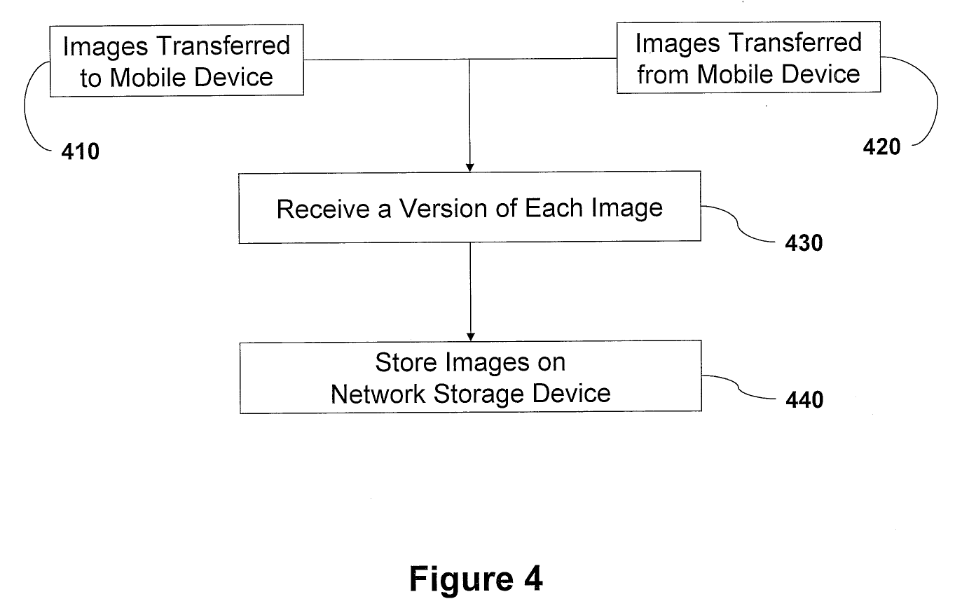

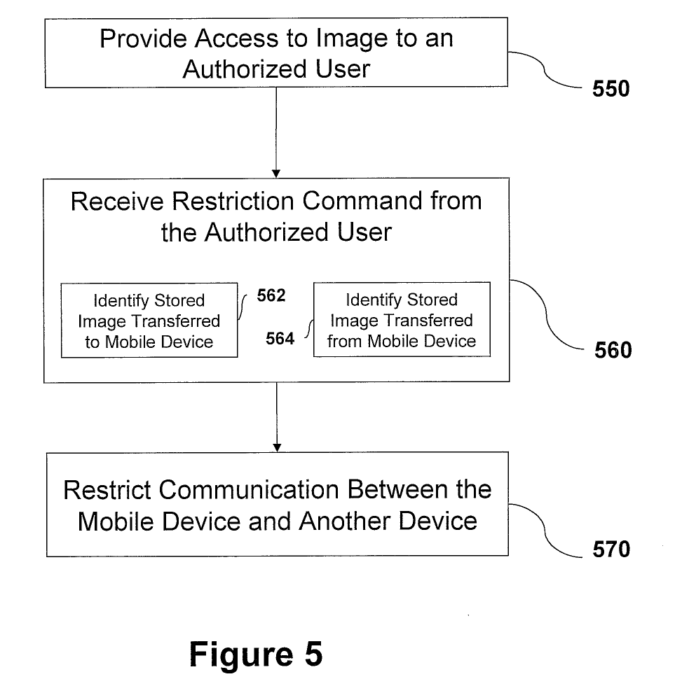

The network storage device 180 further comprises a processor 182 that controls its overall operation by executing computer program instructions which define such operation. The computer program instructions may be stored in the storage device 188 (e.g., magnetic disk, database) and loaded into memory 184 when execution of the computer program instructions is desired. It is noted that the storage 188 may represent one or more of the same or different types of storage devices. Thus, the operation of the network storage device 180 will be defined by computer program instructions stored in memory 184 and/or storage 188, and the network storage device 180 will be controlled by processor 182 executing the computer program instructions. The computer program instructions may be used by the network storage device 180 to perform the steps described herein (e.g., the steps shown or described with reference to FIGS. 4 and 5). The network storage device 180 also includes a network interface 189 for communicating with other devices via a network (e.g., the Internet or a cellular network). Input/output 186 represents devices which allow for user interaction with the network storage device 180 (e.g., display, keyboard, mouse, speakers, buttons, etc.). One skilled in the art will recognize that an implementation of an actual device will contain other components as well, and that the device described is a high level representation of some of the components of a logging device for illustrative purposes. It is noted that the network node 160, and its functions described herein, may be implemented using elements similar to those described in FIG. 3 as part of the network storage device 180.

FIG. 4 shows a flow chart of a method of storing images in embodiments of the present invention, and FIG. 5 shows a method of restricting communication between a mobile device and another mobile device in an embodiment of the invention. First, referring to FIG. 4, in step 410, images are transferred to a mobile device being logged. Alternatively or additionally, in step 420, images are transferred from the mobile device being logged. The transfer of images is generally between two mobile devices, but may be between a mobile device and any other device capable of sending and receiving images in embodiments of the invention. It should also be understood that, while the plural, “images” is used, only one image need be transferred to carry out the method of the invention. In step 430, a version of each image is transferred to or from the mobile device of step 410 and/or 420 and received at a network node where the original version or a reduced quality version of the image which was transferred is stored. The images are then stored on the network data storage device in step 440.

FIG. 5 illustrates the steps performed for providing access to the stored images by an authorized user, and for restricting mobile device communications based on the stored images. Access to the network data storage device is provided to the authorized user in step 550. An authorized used may gain access to the logged images (i.e. those on the data storage device 180 which are associated with his account) via a web browser. This may be accomplished by using a username and password combination or any other means of authenticating a user known in the art. Once the authorized user gains access to the logged images, a restriction command may optionally be received from the authorized user in step 560. The restriction command may be a command to disallow some or all communication between a mobile device and another device. The communication may also be restricted based on data associated with the image, i.e., some or all communication with devices or entities associated with a phone number or IP address.

For example, while the authorized user is viewing stored images the user may select a picture for viewing and/or click on a button or text near the picture which is configured to carry out a function of blocking future communication from and/or to a device which sent/received the image. The authorized user may decide to restrict communication based on identifying a stored image transferred to the mobile device in step 562 or a stored image transferred from the mobile device in step 564. Finally, in step 570, communication is restricted between the mobile device and another device. If future communications are sent from or to a restricted device, then such communications are restricted, that is, not sent as anticipated. A message or image may instead be sent to the logged mobile device or the other mobile device indicating as such. For example, a text message may be sent to the mobile device 110 and optionally to the mobile device 120 indicating that, “Your communication has been restricted. Please contact your administrator for further information.” An image indicating that the communication has been restricted or blocked may be sent in place of the original image desired to be sent. In this manner, the authorized used is able to view images, send a restriction command, and restrict communication between a mobile device under his control and another mobile device based on the restriction command received from the authorized user.

In order to more clearly describe the invention, examples are provided herein. A mobile device associated with a telephone number 555-555-1111 might receive a series of images from a mobile device associated with a telephone number 555-555-2222. The '1111 device may be a phone operated by a family member or employee of an authorized user. Images to the '1111 device are logged. The authorized user, in this example, may be a party who pays for the mobile service plan. The image sent from the '2222 device to the '1111 device may be sent via a communication channel, such as the wireless or cellular network, and, at a network node of the cellular provider, in step 430, the image is received, and the image is copied to a network storage device in step 440 and logged. The authorized user, such as the person or entity paying for the mobile service plan can then access the log (see step 550). If, for example, he disapproves of the communication (i.e. sending or receiving) of an image, he may restrict communication based on the image (see step 560). This may be accomplished by sending a restriction command to a network node which receives the command and carries out the restriction of communication between the logged mobile device and another mobile device. The command may be sent via a web browser. Thus, all further communication from and to the '1111 device which involves the '2222 device may be blocked by the authorized user (see step 570). If the image was associated with an IP (internet protocol) address of the '2222 device instead of or in addition to the phone number, communication to or originating from the device based on the IP address could be blocked instead or in addition. It should also be understood that the communications which are blocked may be any one, or a plurality, of image transfers, data transfers, text messaging, and voice communications to and/or from a device.

We claim:

1. A method for logging images transferred and received via a mobile device comprising the steps of:
receiving at a network node images transferred to or from a mobile device;
storing said received images on a network data storage device; and
providing access to said images stored on said network data storage device only to an authorized user.

2. The method of claim 1, wherein said stored images are reduced quality versions of said received images.

3. The method of claim 1, wherein said stored images are original versions of said received images.

4. The method of claim 1, wherein said storing comprises saving images received at said network node within a sliding time window.

5. The method of claim 1, further comprising:
receiving a restriction command from said authorized user; and
restricting communication between said mobile device and another mobile device based on said restriction command.

6. The method of claim 5, wherein said restriction command identifies a stored image and wherein said another mobile device transferred said image to said mobile device.

7. The method of claim 5, wherein said restriction command identifies a stored image and wherein said another mobile device received said image from said mobile device.

8. The method of claim 1, further comprising:
receiving identification of an image from said authorized user; and
restricting communication between said mobile device and another mobile device that transferred said identified image to said mobile device.

9. The method of claim 1, further comprising:
receiving identification of an image from said authorized user; and
restricting communication between said mobile device and another mobile device that received said identified image from said mobile device.

10. The method of claim 1, wherein said authorized user is a mobile telephone plan subscriber and said mobile device is a mobile telephone within said mobile telephone plan.

11. A device for logging images transferred and received via a mobile device comprising:
means for receiving at a network node images transferred to or from a mobile device;
means for storing said received images on a network data storage device; and
means for providing access to said images stored on said network data storage device only to an authorized user.

12. The device of claim 11, wherein said stored images are reduced quality versions of said received images.

13. The device of claim 11, wherein said stored images are original versions of said received images.

14. The device of claim 11, wherein said storing comprises saving images received at said network node within a sliding time window.

15. The device of claim 11, further comprising:
means for receiving a restriction command from said authorized user; and
means for restricting communication between said mobile device and another mobile device based on said restriction command.

16. The device of claim 15, wherein said restriction command identifies a stored image and wherein said another mobile device transferred said image to said mobile device.

17. The device of claim 15, wherein said restriction command identifies a stored image and wherein said another mobile device received said image from said mobile device.

18. The device of claim 11, further comprising:
means for receiving identification of an image from said authorized user; and
means for restricting communication between said mobile device and another mobile device that transferred said identified image to said mobile device.

19. The device of claim 11, further comprising:
means for receiving identification of an image from said authorized user; and
means for restricting communication between said mobile device and another mobile device that received said identified image from said mobile device.

20. The device of claim 11, wherein said authorized user is a mobile telephone plan subscriber, and said mobile device is a mobile telephone within said mobile telephone plan.
